(19) United States
(12) Patent Application Publication
(10) Pub. No.: US 2024/0217464 A1
(43) Pub. Date: Jul. 4, 2024

(54) Self-Powered Multifunctional Photoelectrical Water Control Truck

(71) Applicant: Andrew ZHOU, Haikou, Hainan (CN)

(72) Inventor: Andrew ZHOU, Haikou, Hainan (CN)

(21) Appl. No.: 17/792,569

(22) PCT Filed: Jul. 23, 2021
(86) PCT No.: PCT/CN2021/108230

§ 371 Date: Jan. 26, 2023

(51) Int. Cl. B60R 16/033; B60P 3/22; H02M 7/00; H02S 10/40; H02S 20/32; H04N 7/18

(52) U.S. Cl. CPC B60R 16/033; B60P 3/2245; B60P 3/228; H02M 7/003; H02S 10/40; H02S 20/32; H04N 7/183

(57) ABSTRACT

The present disclosure relates to the technical field of solar photoelectric water control and photoelectrical water control trucks, and provides a self-powered multifunctional photoelectrical water control truck, including a truck body; a solar battery panel which is arranged at a top and/or a side surface of the truck body and generates direct current under irradiation of the sunshine; an electric control cabinet which is arranged in the truck body, is connected with the solar battery panel and converts the DC generated by the solar battery panel into alternating current which acts as a power supply; an engine which is connected with the electric control cabinet and acquires the AC to provide power for the truck body; and a water control device which is arranged in the truck body, is connected to the electric control cabinet to obtain the AC and is used for water pumping, storage and drainage.

### CROSS REFERENCE TO RELATED APPLICATION

This patent application is a national stage application of International Patent Application No. PCT/CN2021/108230, filed on Jul. 23, 2021, the disclosures of which are incorporated by reference herein in their entireties.

### TECHNICAL FIELD

The present disclosure relates to the technical field of solar photoelectric water control and solar photoelectrical water control trucks, in particular to a self-powered multifunctional photoelectrical water control truck.

### BACKGROUND ART

As renewable energy, solar energy is green and low-carbon energy, which is an important part of a multi-wheel driving energy supply system and is of great significance for improving an energy structure, protecting an ecological environment, dealing with climate changes, and achieving sustainable economic and social development. Solar photoelectric device uses photovoltaic semiconductor materials to convert solar energy into direct current (DC) to provide power for device in various fields.

However, the use scenarios of solar energy in the prior art are relatively limited. Generally, solar energy is only applied to device that requires less power, which greatly limits the development of the solar photoelectric device. There is often no mains supply in the open air and uninhabited areas. It is difficult for large-scale device in the open air, especially water control device and vehicles, to completely rely on solar energy, making these devices unable to truly go deep into the open air and uninhabited areas.

Therefore, there is an urgent need to develop a self-powered multifunctional photoelectrical water control truck, which can complete functions such as driving and water control only by relying on solar energy, and realize full application of solar energy.

### SUMMARY

The present disclosure aims to provide a self-powered multifunctional photoelectrical water control truck, which can complete functions such as driving and water control only by relying on solar energy, and can go deep into the open air and uninhabited areas to realize full application of solar energy.

In order to solve the above-mentioned technical problems, as a first aspect of the present disclosure, a self-powered multifunctional photoelectrical water control truck is provided, including:
a truck body;
a solar battery panel which is arranged at a top and/or a side surface of the truck body and generates direct current (DC) under irradiation of sunshine;
an electric control cabinet which is arranged in the truck body, is connected with the solar battery panel and converts the DC generated by the solar battery panel into alternating current (AC) which acts as a power supply for power supplying;
an engine which is connected with the electric control cabinet and receives the AC to provide power for driving the truck body; and
a water control device which is arranged in the truck body, is connected with the electric control cabinet to receive the AC and is configured for water pumping, water storage and water drainage.

Further, the self-powered multifunctional photoelectrical water control truck further includes a camera device, a remote device and a control system;
the control system is connected with the electric control cabinet, the water control device, the camera device and the remote device and is configured for controlling turning on and turning off of the electric control cabinet, the water control device, the camera device and the remote device;
the camera device is arranged on an outer side of the truck body and is configured for photographing water pumping and/or water drainage conditions of the water control device;
the remote device sends a video taken by the camera device, a running condition of the electric control cabinet and a running condition of the water control device to a terminal device through a wireless network, and receives an instruction from the terminal device to control the control system; and the terminal device includes a mobile phone or a computer.

Further, the self-powered multifunctional photoelectrical water control truck further includes a bank settlement device and a water volume calculation device;
the water volume calculation device calculates a water consumption volume according to a water pumping volume or a water drainage volume of the water control device;
the bank settlement device is connected with the water volume calculation device and is configured for calculating a water charge according to the water consumption volume and making a settlement of water charge with a bank water payment system through the wireless network.

Further, the self-powered multifunctional photoelectrical water control truck further includes a water treatment device, an illumination device and a peripheral connector;
the water treatment device is connected with the electric control cabinet to receive the AC and performs water treatment on water in the water control device;
the illumination device is connected with the electric control cabinet to receive the AC and provides illumination for interior of the truck body and/or exterior of the truck body;
the peripheral connector is connected with the electric control cabinet to receive the AC and provides power for electrical appliances outside the truck body; and the electrical appliances include a rice husking machine, a plough, an irrigation device or a cutting device.

Further, the self-powered multifunctional photoelectrical water control truck further includes a changeover device and a battery pack;
the changeover device is connected with the solar battery panel, the electric control cabinet and the battery pack; when surplus DC remains after the DC is supplied to the electric control cabinet, the changeover device supplies the surplus DC to the battery pack for charging; and when the DC of the solar battery panel does not meet a need of the electric control cabinet, the changeover device receives DC from the battery pack for supplementation.

Further, the self-powered multifunctional photoelectrical water control truck further includes a sun tracking apparatus; the sun tracking apparatus is connected with the solar battery panel and is configured for adjusting an angle of the solar battery panel to make the solar battery panel to be perpendicular to the sunshine.

Preferably, the sun tracking apparatus includes a plurality of telescoping mechanisms and an angle calculation mechanism;
one end of each telescoping mechanism is fixed on the truck body, and another end of each telescoping mechanism is fixedly connected to a bottom of the solar battery panel; the angle of the solar battery panel is adjusted by extension and retraction of the telescoping mechanisms;
the angle calculation mechanism is connected with the telescopic mechanisms, calculates an included angle between the sunshine and ground, and instructs, according to the included angle, the telescoping mechanism to adjust the angle of the solar battery panel.

More preferably, the angle calculation mechanism calculates the included angle between the sunshine and the ground according to a current time, a current latitude and a current longitude.

Further, the self-powered multifunctional photoelectrical water control truck further includes a DC protection mechanism and an AC protection mechanism which are arranged between the solar battery panel and the electric control cabinet;
the DC protection mechanism includes a first electromagnetic valve; the first electromagnetic valve is connected with the solar battery panel; when a current of the solar battery panel reaches a first designated current threshold, the first electromagnetic valve is closed, and the solar battery panel supplies power to the DC protection mechanism;
the AC protection mechanism includes a second electromagnetic valve; the second electromagnetic valve is arranged between the DC protection mechanism and the electric control cabinet; when a current of the DC protection mechanism reaches a second designated current threshold, the second electromagnetic valve is closed; and the DC protection mechanism supplies a DC to the electric control cabinet.

Further, the self-powered multifunctional photoelectrical water control truck further includes a motor protection mechanism; the water control device includes a motor; the motor is connected with the electric control cabinet and is configured for supplying power for water pumping and/or water drainage of the water control device; the motor protection mechanism is connected with the electric control cabinet to monitor a current frequency of the AC of the electric control cabinet; and when the current frequency of the AC of the electric control cabinet reaches a designated current frequency threshold, the motor protection mechanism instructs the electric control cabinet to supply power to the motor.

Further, the electric control cabinet includes an inverter, and the inverter converts the DC into an AC.

The present disclosure has the following beneficial effects:

The devices on the photoelectrical water control truck of the present disclosure include an engine for driving the photoelectrical water control truck to run, a water control device, a control system, a camera device and the like, all of which use the power supplied by the solar battery panel. The photoelectrical water control truck can be independently used in the open air and uninhabited areas. Power can also be supplied to other electrical appliances including a husking machine, a plough and the like outside the truck body. Remote terminal control and water charge settlement can also be achieved, thus realizing various functions of the photoelectrical water control truck. By the adoption of the sun tracking apparatus, the solar battery panel can be perpendicular to the sunshine as much as possible, so that the solar battery panel obtains full solar energy. By the adoption of the DC protection mechanism and the AC protection mechanism, the devices on the photoelectrical water control truck can be awakened at the sun rise, and it can also be ensured that a current of an entire circuit may not be too low, thus preventing burning of the electrical appliances due to heavy loads.

### BRIEF DESCRIPTION OF THE DRAWINGS

FIG. 1 schematically shows a three-dimensional diagram of a self-powered multifunctional photoelectrical water control truck;

FIG. 2 schematically shows a front view of a photoelectrical water control truck;

FIG. 3 schematically shows a rear view of a self-powered multifunctional photoelectrical water control truck;

FIG. 4 schematically shows a flowing direction diagram of a current between devices in a self-powered multifunctional photoelectrical water control truck;

FIG. 5 schematically shows a top view of a self-powered multifunctional photoelectrical water control truck wherein solar battery panels on side surfaces extend;

FIG. 6 schematically shows a three-dimensional diagram of a self-powered multifunctional photoelectrical water control truck wherein solar battery panels on side surfaces extend;

FIG. 7 schematically shows a front view of a self-powered multifunctional photoelectrical water control truck wherein solar battery panels on side surfaces extend;

FIG. 8 schematically shows a left view of a self-powered multifunctional photoelectrical water control truck wherein solar battery panels on side surfaces extend;

FIG. 9 schematically shows a right view of a self-powered multifunctional photoelectrical water control truck wherein solar battery panels on side surfaces extend;

FIG. 10 schematically shows a structural diagram of a sun tracking apparatus;

FIG. 11 schematically shows a structural diagram of a solar battery panel with an inclination angle;

FIG. 12 schematically shows a structural diagram of a water control device.

1: truck body; 2: solar battery panel; 3: electric control cabinet; 4: engine; 5: water control device; 51: motor; 52: negative pressure tank; 53: first water-storage and pressure-adjustment tank; 54: second water-storage and pressure-adjustment tank; 55: siphon pump; 56: water inlet pipe; 57: water drainage pipe; 58: connection pipe; 59: check valve; 6: camera device; 7: remote device; 8: control system; 9: bank settlement device; 10: water volume calculation device; 11: water treatment device; 12: illumination device; 13: peripheral connector; 14: changeover device; 15: battery pack; 16: sun tracking apparatus; 161: telescoping mechanism; 162: angle calculation mechanism; 17: DC protection mechanism; 18: AC protection mechanism; and 19: motor protection mechanism.

### DETAILED DESCRIPTION OF THE EMBODIMENTS

The embodiments of the present disclosure are described in detail below. However, the present disclosure can be implemented in various different ways defined and covered by the claims.

In order to make those skilled in the art better understand the solutions of the present disclosure, the technical solutions in the embodiments of the present disclosure will be described clearly and completely below in combination with the drawings in the embodiments of the present disclosure. Obviously, the embodiments described herein are only part of the embodiments of the present disclosure, not all the embodiments. Based on the embodiments in present disclosure, all other embodiments obtained by those of ordinary skill in the art without creative work shall fall within the protection scope of the present disclosure.

In the description of the embodiments of the present disclosure, it should be noted that orientations or positional relationships indicated by the terms “center”, “upper”, “lower”, “left”, “right”, “vertical”, “horizontal”, “inside”, “outside” and the like are orientations or positional relationships as shown in the drawings, and are only for the purpose of facilitating and simplifying the description of the embodiments of the present disclosure instead of indicating or implying that devices or elements indicated must have particular orientations, and be constructed and operated in the particular orientations, so that these terms are not construed as limiting the embodiments of the present disclosure. In addition, the terms “first”, “second” and “third” are only for the purpose of description, and may not be understood as indicating or implying the relative importance.

In the description of the embodiments of the present disclosure, it should be also noted that unless otherwise explicitly defined and defined, the terms “mounted”, “coupled” and “connected” shall be understood broadly, and may be, for example, fixedly connected, or detachably connected, or integrally connected, or mechanically connected, or electrically connected, or directly connected, or indirectly connected through an intermediate medium, or interconnection between two elements. Those of ordinary skill in the art can understand the specific meanings of the above terms in the embodiments of the present disclosure according to specific situations.

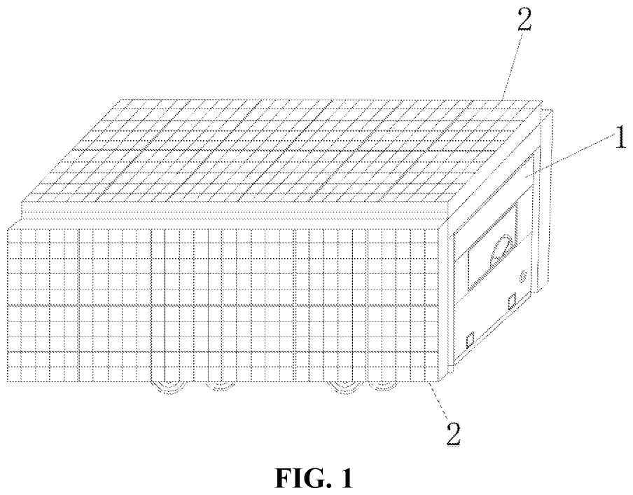

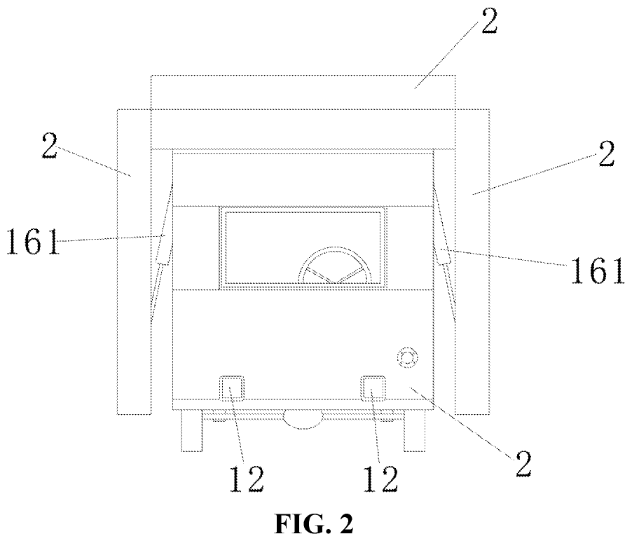

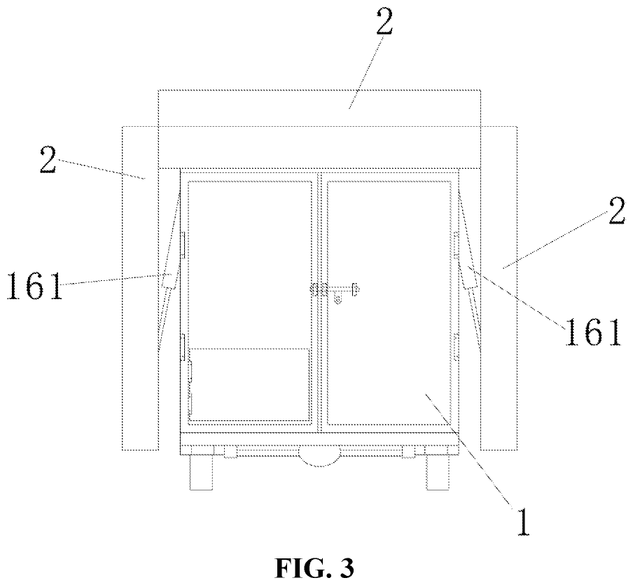

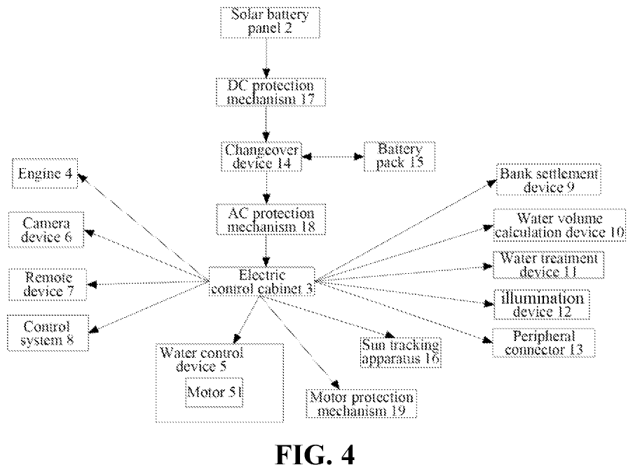

As a first implementation of the present disclosure, a self-powered multifunctional photoelectrical water control truck is provided. The photoelectrical water control truck refers to a water control truck for converting light energy of solar energy into electric energy. Being self-powered means that electric energy used for running of the water control truck is converted from light energy of solar energy, and power of running can be supplied to the photoelectrical water control truck only by solar energy. As shown in FIG. 1, FIG. 2, FIG. 3 and FIG. 4, the photoelectrical water control truck includes a truck body 1, a solar battery panel 2, an electric control cabinet 3, an engine 4, a water control device 5, a camera device 6, a remote device 7, a control system 8, a bank settlement device 9, a water volume calculation device 10, a water treatment device 11, a illumination device 12, a peripheral connector 13, a changeover device 14, a battery pack 15, a sun tracking apparatus 16, a DC protection mechanism 17, an AC protection mechanism 18 and a motor protection mechanism 19.

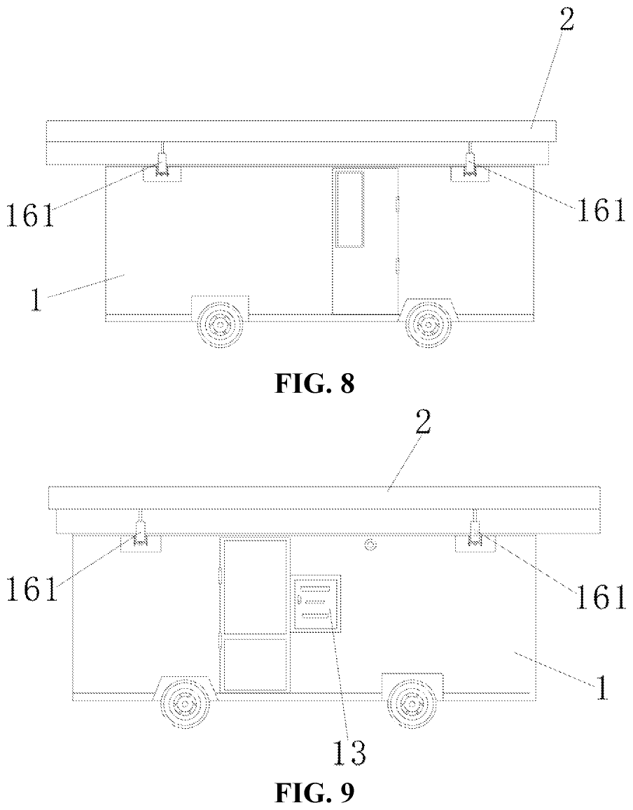

The truck body 1 is used as a framework of the entire photoelectrical water control truck, and all the devices are arranged on the truck body 1 to form a complete whole. As shown in FIG. 1 and FIG. 2, a front side of the truck body 1 is provided with a cab, and working staff can enter the cab to drive the photoelectrical water control truck. In this way, the photoelectrical water control truck can conveniently move from one place to another place. The working staff can drive the photoelectrical water control truck to a place where the photoelectrical water control truck is required. No special trailer is needed, and no more fixed land resources need to be occupied. When the photoelectrical water control truck is not required, the working staff can drive it away from the place. As shown in FIG. 3, a rear side of the truck body 1 is provided with a rear door. The main function of the photoelectrical water control truck is to control water. The water control device 5 is arranged at a rear part in the truck body 1. The rear door is opened to directly use the water control device. As shown in FIG. 8 and FIG. 9, left and right sides of the truck body 1 are provided with side doors for the working staff to get into the truck body 1 and the cab. In this embodiment, the left and right sides are provided with the side doors. In practice, the side door can be provided on one side as required. In this embodiment, the electric control cabinet 3, the engine 4, the water control device 5, the remote device 7, the control system 8, the bank settlement device 9, the water treatment device 11, the changeover device 14, the battery pack 15, the DC protection mechanism 17, the AC protection mechanism 18 and the motor protection mechanism 19 are all provided in the truck body 1.

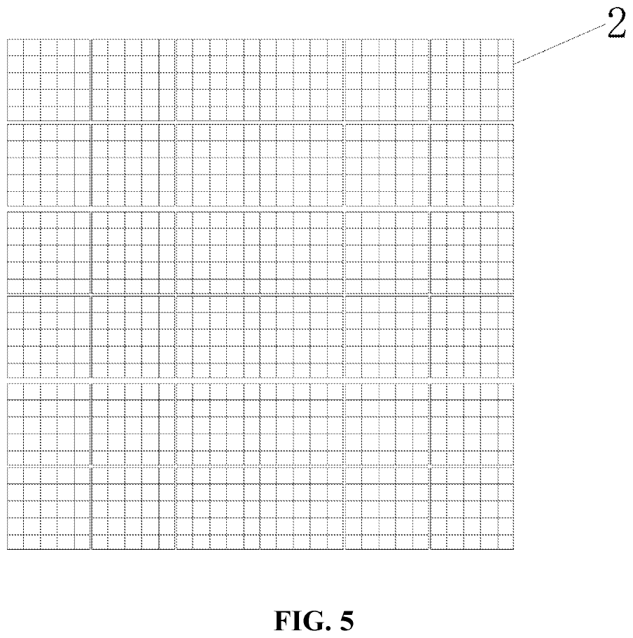

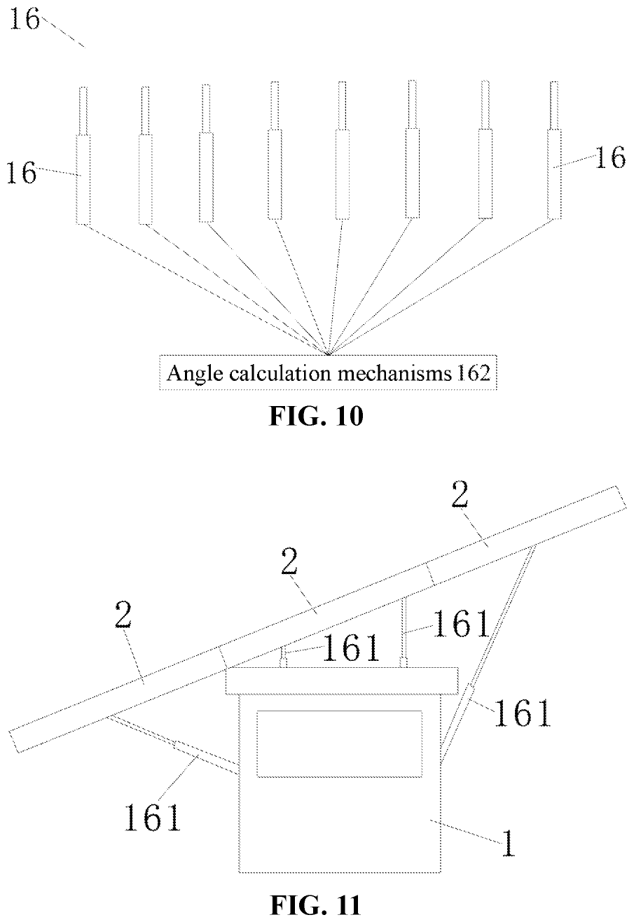

As shown in FIG. 1, FIG. 2 and FIG. 3, the solar battery panels 2 are arranged at the top and two side surfaces of the truck body 1. The solar battery panel 2 at the top is horizontally disposed, and the solar battery panels 2 on the side surfaces are vertically disposed. In order to obtain solar energy to the maximum extent, in this embodiment, the top and side surfaces of the truck body 1 are all provided with the solar battery panels 2. If only the top is provided with the solar battery panel, obtained solar energy is only ⅓ of that in this embodiment. As shown in FIG. 5 to FIG. 9, the solar battery panels 2 on the side surfaces can be flipped to the same plane as the solar battery panel 2 at the top and face to the sun to obtain solar energy. After the solar battery panels 2 on the side surfaces are flipped, the working staff can get into the truck body 1 from the side door on the side surface of the truck body 1. By the adoption of the turnable solar battery panels 2, the space can also be fully used, thus obtaining solar energy to the maximum extent. Solar energy is clean energy. The solar battery panel 2 directly or indirectly converts the solar energy into DC through a photoelectric effect or a photochemical effect and supplies the DC to the entire photoelectrical water control truck. When the solar battery panel 2 is perpendicular to the sunshine, most solar energy can be obtained. In order to obtain more solar energy, in this solution, the sun tracking apparatus 16 is provided, so that the solar battery panel 2 is always kept perpendicular to the sunshine. As shown in FIG. 10, the sun tracking apparatus 16 includes a plurality of telescoping mechanisms 161 and an angle calculation mechanism 162. The angle calculation mechanism 162 is connected with the plurality of telescoping mechanisms 161. An included angle between the sunshine and the ground is calculated according to current time, a current latitude and a current longitude, and the telescoping mechanisms 161 are instructed, according to the included angle, to adjust an angle of the solar battery panel 2. In this solution, there are a total eight telescoping mechanisms 161 of the sun tracking apparatus 16. Four telescoping mechanisms 161 control the solar battery panel 2 at the top; two telescoping mechanisms 161 control the solar battery panel 2 on the left side; and two telescoping mechanisms 161 control the solar battery panel 2 on the right side. As shown in FIG. 11, one end of each telescoping mechanism 161 is fixed at a top or on a side surface of the truck body 1, and the other end of each telescoping mechanism is fixedly connected to a bottom of the solar battery panel 2; the angle of the solar battery panel 2 is adjusted by extension and retraction of the telescoping mechanisms 161. For example, when the angle calculation mechanism 162 calculates a height of the sunshine according to the current time, the current latitude of the position of the photoelectrical water control truck and a longitudinal longitude of the position of the photoelectrical water control truck, thus calculating the included angle between the sunshine and the ground. The angle calculation mechanism 162 instructs the telescoping mechanisms 161 to adjust the angles of the solar battery panels 2. As shown in FIG. 11, for the telescoping mechanisms 161 located on the two sides, the left telescoping mechanism 161 is shorter, and the right telescoping mechanism 161 is longer; for the telescoping mechanisms 161 located at the top, the left telescoping mechanism 161 is shorter, and the right telescoping mechanism 161 is longer; the three solar battery panels 2 are located on the same panel; and this plane is perpendicular to the sunshine. When the angle of the sunshine changes, the angles of the solar battery panels 2 are appropriately adjusted through the telescoping mechanisms 161, so that the solar battery panels 2 are always kept at the positions perpendicular to the sunshine. When the sun goes down or when solar energy cannot be used in a cloudy day or a rainy day, the solar battery panels 2 return to the positions in FIG. 1 to FIG. 3 to reduce the occupation of the space. At the sun rise or under other conditions where solar energy can be used (for example, cloudy to sunny and rainy to sunny), the solar battery panels 2 are re-adjusted in angles to be perpendicular to the sunshine.

Different from the use of the mains supply, the mains supply can provide power 24 hours a day, and the power provided by solar energy is greatly dependent on the sun. When the sun goes down or the sun is covered by clouds, solar energy cannot be provided, which will inevitably affect the use of the devices on the photoelectrical water control truck. This embodiment makes full use of solar energy based on two aspects, namely: First, in this embodiment, a changeover device 14 and a battery pack 15 are provided. The changeover device 14 is connected to the solar battery panel 2, the electric control cabinet 3 and the battery pack 15. When surplus DC remains after the DC of the solar battery panels 2 is supplied to the electric control cabinet 3, the changeover device 14 supplies the surplus DC to the battery pack 15 for charging. When the DC of the solar battery panels 2 does not meet a need of the electric control cabinet 3, the changeover device 14 receives DC from the battery pack 15 for supplementation. Second, in this embodiment, a DC protection mechanism 17 and an AC protection mechanism 18 are provided, which can protect a circuit and devices that require power of an entire power supply system and also detect the sunshine at the sun rise. The entire power supply system is turned on to supply power only if the solar energy meets a supply requirement, so that the long-time utilization of the solar energy is maximized. Specifically, the DC protection mechanism 17 and the AC protection mechanism 18 are arranged between the solar battery panels 2 and the electric control cabinet 3. In this embodiment, the DC protection mechanism 17 is arranged between the solar battery panels 2 and the changeover device 14, and supplies DC to the AC protection mechanism 18 via the changeover device 14. The AC protection mechanism 18 is arranged between the changeover device 14 and the electric control cabinet 3 to protect AC generated by the electric control cabinet 3. The DC protection mechanism 17 includes a first electromagnetic valve; the first electromagnetic valve is connected with the solar battery panels 2; when currents of the solar battery panels 2 reach a first designated current threshold, the first electromagnetic valve is closed, and the solar battery panels 2 supply DC to the DC protection mechanism 17. The DC protection mechanism 17 is equivalent to a mechanism that initially wakes up the entire power supply system. If the solar battery panel 2 generate a current exceeding the first designated current threshold, it indicates that the solar energy is relatively stable or gradually tends to be stable, which prevents the DC protection mechanism 17 from being affected by an unstable current. For example, if light irradiates the solar battery panels 2 at night, a weak current may be induced, but the current may not be greater than the first designated current threshold. At this time, setting the first designated current threshold can prevent the DC protection mechanism 17 or even the AC protection mechanism 18 and other devices from being affected by unstable factors, thus protecting the devices. The AC protection mechanism 18 includes a second electromagnetic valve. When the current of the DC protection mechanism 17 reaches a second designated current threshold, the second electromagnetic valve is closed, and the DC protection mechanism 17 provides DC to the electric control cabinet 3 via the changeover device 14 and the AC protection mechanism 18 to ensure that AC generated by the electric control cabinet 3 is relatively stable.

The electric control cabinet 3 includes an inverter that converts DC into AC, as shown in FIG. 4, and serves as a power supply which supplies power to the engine 4, the water control device 5, the camera device 6, the remote device 7, the control system 8, the bank settlement device 9, the water volume calculation device 10, the water treatment device 11, the illumination device 12, the peripheral connector 13, the sun tracking apparatus 16 and the motor protection mechanism 19.

The engine 4 is connected to the electronic control cabinet 3 and receives AC to provide power for the truck body 1 to travel or walk. At present, it is difficult to directly supply electricity generated by solar energy to the engine in the market, and gasoline or diesel is basically used to supply power the engine. However, gasoline or diesel pollutes the environment, and the truck body is unable to walk when there is no gasoline or diesel in the open air or uninhabited areas. The electric control cabinet 3 of this embodiment can convert a 37V DC of solar energy into a 380V high-voltage AC and supply it to the engine 4, so that the engine 4 can drive the entire photoelectrical water control truck to walk with only the solar energy, which greatly expands the application range of the photoelectrical water control truck.

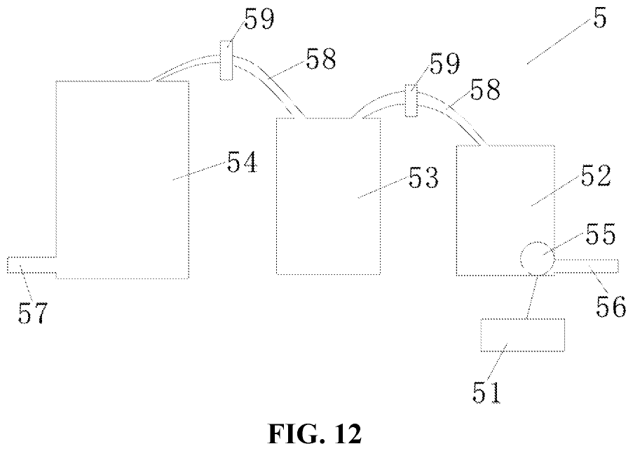

The water control device 5 is the main function of the photoelectrical water control truck. As shown in FIG. 12, it includes a motor 51, a negative pressure tank 52, a first water-storage and pressure-adjustment tank 53, a second water-storage and pressure-adjustment tank 54, a siphon pump 55, a water inlet pipe 56, a water drainage pipe 57, a connection pipe 58 and a check valve 59. The siphon pump 55 is arranged in the negative pressure tank 52 and is connected to the motor 51, and the motor 51 provides the siphon pump 55 with power for water pumping. The water inlet pipe 56 is connected with the negative pressure tank 52 through the siphon pump 55. The negative pressure tank 52 is connected with the first water-storage and pressure-adjustment tank 53 through the connection pipe 58; the first water-storage and pressure-adjustment tank 53 is connected with the second water-storage and pressure-adjustment tank 54 through the connection pipe 58; and the second water-storage and pressure-adjustment tank 54 is connected with the water drainage pipe 57. The siphon pump 55 pumps water; the first water-storage and pressure-adjustment tank 53 and the second water-storage and pressure-adjustment tank 54 store water; the water drainage pipe 57 drains water; and the water pumping, water storage and water drainage functions of the water control device 5 are realized. The connection pipe 58 is also provided with the check valve 59 to prevent backflow of water. The motor 51 of the water control device 5 receives AC from the electric control cabinet 3 and provides power for the siphon pump 55. If mains supply is used to supply power to the motor 51, the motor 51 can work under stable voltage and current. However, the photoelectrical water control truck uses solar energy. When solar energy is unstable, a generated AC has a low current frequency, which easily causes the motor 51 to be overloaded and causes a coil to be continuously heated, resulting in a damage to the motor 51. As a result, the motor 51 is continuously replaced, which increases the operating cost. Furthermore, the photoelectrical water control truck works in the open air and an uninhabited area most of the time. If the motor 51 fails, this photoelectrical water control truck loses its main function and cannot be used. Therefore, the motor protection mechanism 19 connected to the electric control cabinet 3 is provided to monitor the current frequency of the AC of the electric control cabinet 3. When the current frequency of the AC of the electric control cabinet 3 reaches a designated current frequency threshold, the motor protection mechanism 19 instructs the electric control cabinet 3 to supply power to the motor 51. When the current frequency of the AC of the electric control cabinet 3 does not reach the designated current frequency threshold, the motor protection mechanism 19 instructs the electric control cabinet 3 not to supply power to the motor 51. Only when the voltage and current generated by the inverter of the electric control cabinet 3 are stable to make the motor 51 not easily damaged during running, the motor 51 is turned on. The motor protection mechanism 19 includes a third electromagnetic valve, which is controlled by an embedded software program. The electric control cabinet 3 and the motor 51 are turned on only after the current frequency reaches a set desired frequency (the designated current frequency). This is equivalent to generating a magnetic field by the current to close and open a switch.

The water treatment device 11 is connected to the electric control cabinet 3 to receive AC, and performs water treatment on water in the water control device 5. The water may be water that has just entered the water inlet pipe 56, or water that is being stored, or water that is about to be drained from the water drainage pipe 57.

The water volume calculation device 10 calculates a water consumption volume according to a water pumping volume or a water drainage volume of the water control device 5, and can use a flow sensor arranged in the water inlet pipe 56 or the water drainage pipe 57, or can calculate a flow rate by monitoring a water outlet through a video.

The bank settlement device 9 is connected to the water volume calculation device 10 and is used for calculating a water charge according to the water consumption volume and making a settlement of the water charge with a bank water payment system through a wireless network.

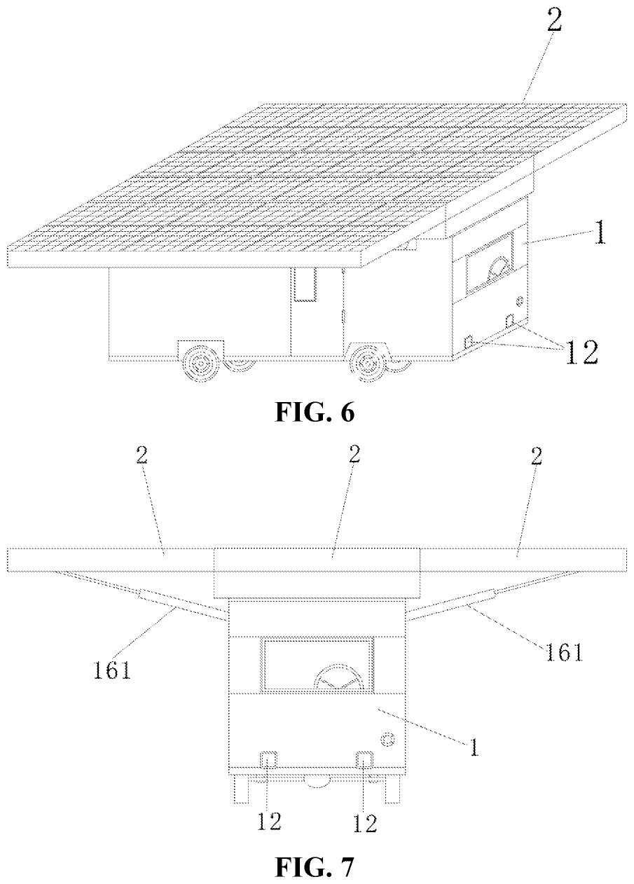

The illumination device 12 is connected with the electric control cabinet 3 to receive the AC and provides illumination for the interior of the truck body 1 and/or the exterior of the truck body. The illumination device 12 in FIG. 1, FIG. 2, FIG. 6 and FIG. 7 is arranged outside the truck body 1 and is used as a vehicle lamp. Partial illumination devices 12 are arranged inside the truck body 1.

The peripheral connector 13 is connected with the electric control cabinet 3 to receive the AC and provides power for electrical appliances outside the truck body 1. The electrical appliances include a rice husking machine, a plough, an irrigation device and a cutting device. As shown in FIG. 9, the peripheral connector 13 is arranged outside the truck body 1, so that the electrical appliances receive the power more conveniently.

The camera device 6 is arranged on an outer side of the truck body 1 and is used for photographing water pumping and/or water drainage conditions of the water control device 5. The water control device 5 is arranged at the rear part of the truck body 1, and the camera device 6 can be arranged at the rear part of the outer side of the truck body 1, so that it is convenient to photograph the water pumping and/or water drainage conditions.

The remote device 7 sends a video taken by the camera device 6, a running condition of the electric control cabinet 3 and a running condition of the water control device 5 (particularly a running condition of the motor 51) to a terminal device through a wireless network, and receives an instruction from the terminal device to control the control system 8. The terminal device includes a mobile phone and a computer arranged remotely. When the photoelectrical water control truck is independently placed in the open air and the uninhabited area, it can be unattended through the remote device 7, which saves human resources.

The control system 8 is connected with the electric control cabinet 3, the motor 51 of the water control device 5, the camera device 6 and the remote device 7, and is used for receiving power from the electric control cabinet 3 and controlling the motor 51, the camera device 6 and the remote device 7 to be turned on and turned off.

In the case of only solar energy, the photoelectrical water control truck of the present disclosure can realize various functions such as driving, water control, water consumption calculation, water charge settlement, remote monitoring and power supplying, can be independently used in the open air and the uninhabited area, and can be unattended.

The above descriptions are merely preferred embodiments of the present disclosure and are not intended to limit the present disclosure. For those skilled in the art, the present disclosure may have various modifications and changes. Any modifications, equivalent replacements, improvements, and the like that are made within the spirit and principle of the present disclosure shall all fall within the protection scope of the present disclosure.

What is claimed is:

1. A self-powered multifunctional photoelectrical water control truck, comprising:
a truck body;
a solar battery panel which is arranged at a top and/or a side surface of the truck body and generates direct current (DC) under irradiation of sunshine;
an electric control cabinet which is arranged in the truck body, is connected with the solar battery panel, and converts the DC generated by the solar battery panel into alternating current (AC) which acts as a power supply for power supplying;
an engine which is connected with the electric control cabinet and receives the AC to provide power for driving the truck body; and
a water control device which is arranged in the truck body, is connected with the electric control cabinet to receive the AC, and is configured for water pumping, water storage and water drainage.

2. The self-powered multifunctional photoelectrical water control truck according to claim 1, further comprising a camera device, a remote device and a control system,
the control system is connected with the electric control cabinet, the water control device, the camera device and the remote device, and is configured for controlling turning on and turning off of the electric control cabinet, the water control device, the camera device and the remote device;
the camera device is arranged on an outer side of the truck body and is configured for photographing water pumping and/or water drainage conditions of the water control device;
the remote device sends a video taken by the camera device, a running condition of the electric control cabinet and a running condition of the water control device to a terminal device through a wireless network, and receives an instruction from the terminal device to control the control system; and the terminal device comprises a mobile phone or a computer.

3. The self-powered multifunctional photoelectrical water control truck according to claim 1, further comprising a bank settlement device and a water volume calculation device;
wherein the water volume calculation device calculates a water consumption volume according to a water pumping volume or a water drainage volume of the water control device;
the bank settlement device is connected with the water volume calculation device and is configured for calculating a water charge according to the water consumption volume and making a settlement of water charge with a bank water payment system through the wireless network.

4. The self-powered multifunctional photoelectrical water control truck according to claim 1, further comprising a water treatment device, an illumination device and a peripheral connector,
the water treatment device is connected with the electric control cabinet to receive the AC and performs water treatment on water in the water control device;
the illumination device is connected with the electric control cabinet to receive the AC and provides illumination for interior of the truck body and/or exterior of the truck body;
the peripheral connector is connected with the electric control cabinet to receive the AC and provides power for electrical appliances outside the truck body; and the electrical appliances comprise a rice husking machine, a plough, an irrigation device or a cutting device.

5. The self-powered multifunctional photoelectrical water control truck according to claim 1, further comprising a changeover device and a battery pack,
the changeover device is connected with the solar battery panel, the electric control cabinet and the battery pack; when surplus DC remains after the DC is supplied to the electric control cabinet, the changeover device supplies the surplus DC to the battery pack for charging; and when the DC of the solar battery panel does not meet a need of the electric control cabinet, the changeover device receives DC from the battery pack for supplementation.

6. The self-powered multifunctional photoelectrical water control truck according to claim 1, further comprising a sun tracking apparatus, wherein the sun tracking apparatus is connected with the solar battery panel and is configured for adjusting an angle of the solar battery panel to make the solar battery panel to be perpendicular to sunshine.

7. The self-powered multifunctional photoelectrical water control truck according to claim 6, wherein the sun tracking apparatus comprises a plurality of telescoping mechanisms and an angle calculation mechanism;
one end of each telescoping mechanism is fixed on the truck body, and another end of each telescoping mechanism is fixedly connected to a bottom of the solar battery panel;
the angle of the solar battery panel is adjusted by extension and retraction of the telescoping mechanisms;
the angle calculation mechanism is connected with the telescopic mechanisms, calculates an included angle between the sunshine and ground, and instructs, according to the included angle, the telescoping mechanisms to adjust the angle of the solar battery panel.

8. The self-powered multifunctional photoelectrical water control truck according to claim 7, wherein the angle calculation mechanism calculates the included angle between the sunshine and the ground according to a current time, a current latitude and a current longitude.

9. The self-powered multifunctional photoelectrical water control truck according to claim 1, further comprising a DC protection mechanism and an AC protection mechanism which are arranged between the solar battery panel and the electric control cabinet,
the DC protection mechanism comprises a first electromagnetic valve; the first electromagnetic valve is connected with the solar battery panel; when a current of the solar battery panel reaches a first designated current threshold, the first electromagnetic valve is closed, and the solar battery panel supplies power to the DC protection mechanism;
the AC protection mechanism comprises a second electromagnetic valve; the second electromagnetic valve is arranged between the DC protection mechanism and the electric control cabinet; when a current of the DC protection mechanism reaches a second designated current threshold, the second electromagnetic valve is closed; and the DC protection mechanism supplies a DC to the electric control cabinet.

10. The self-powered multifunctional photoelectrical water control truck according to claim 9, further comprising a motor protection mechanism, wherein the water control device comprises a motor; the motor is connected with the electric control cabinet and is configured for supplying power for water pumping and/or water drainage of the water control device; the motor protection mechanism is connected with the electric control cabinet to monitor a current frequency of the AC of the electric control cabinet; and when the current frequency of the AC of the electric control cabinet reaches a designated current frequency threshold, the motor protection mechanism instructs the electric control cabinet to supply power to the motor.
